(19) United States
(12) Patent Application Publication
(10) Pub. No.: US 2025/0002072 A1
(43) Pub. Date: Jan. 2, 2025

(54) STEERING ASSEMBLY FOR A VEHICLE

(71) Applicant: ZF Automotive UK Limited, Solihull (GB)

(72) Inventors: Mark Wilkes, Birmingham (GB); Russell Wilson-Jones, Stratford Upon Avon (GB)

(21) Appl. No.: 18/755,863

(22) Filed: Jun. 27, 2024

(30) Foreign Application Priority Data
Jun. 30, 2023 (GB) 2310084.5

(51) Int. Cl. B62D 5/00

(52) U.S. Cl. CPC B62D 5/005

(57) ABSTRACT

A steering column assembly for a vehicle includes an elongate steering shaft mounted for rotation about its longitudinal axis and configured for attachment of a steering member at one end. The steering shaft is rotatable in both directions from a position corresponding to a straight ahead position. A cam member has a cam surface. The cam member is constrained to rotate with the steering shaft. A cam follower is in contact with the cam surface. A lever is connected to a lever pivot and arranged to support the cam follower. A spring means is connected to the lever and biases the cam follower into contact with the cam surface via the lever. The spring means urges the cam follower to displace the cam member in a direction which returns the elongate steering shaft towards the straight ahead position.

### TECHNICAL FIELD

This invention relates to steering assemblies for vehicles and to motor vehicles comprising such steering assemblies. More specifically, although not exclusively, this invention relates to steering assemblies for use in steer-by-wire vehicles.

### BACKGROUND

Traditional vehicle steering systems utilise a constant mechanical connection between the steering wheel and the steered wheels. However, the trend towards steer-by-wire steering systems breaks the traditional mechanical connection and replaces it with a digital control signal. Specifically, a steering input is applied through a steering wheel. A signal is transmitted to a steering axle actuator in dependence on the steering input, controlling motion of the steering rack and the degree to which the steered wheels are pivoted. Due to the absence of a mechanical connection between the steering wheel and steering rack, it is often desired to provide a feedback torque to the steering wheel in the opposite direction to the steering input, in order to provide a sensation of road feel to the driver.

In a traditional vehicle steering system, when a driver removes or reduces the applied torque on the steering wheel, the mechanical connection between the steering wheel and the steered wheels of the vehicle naturally applies a torque to the steering wheel in the opposite direction of the previously-applied torque, which assists in returning the steering wheel towards its straight ahead position, but no such torque is generated in a steer-by-wire steering system. Consequently, with a steer-by-wire steering system it is necessary for a driver to return the steering wheel manually to the straight ahead position.

### SUMMARY

In accordance with the present invention, a steering column assembly for a vehicle, comprises:
an elongate steering shaft mounted for rotation about its longitudinal axis and configured for attachment of a steering member at one end, the steering shaft being rotatable in both directions from a position corresponding to a straight ahead position;
a cam member comprising a cam surface, wherein the cam member is constrained to rotate with the elongate steering shaft;
a cam follower in contact with the cam surface;
a lever connected to a lever pivot and arranged to support the cam follower; and
spring means connected to the lever and biasing the cam follower into contact with the cam surface via the lever;
wherein spring means urges the cam follower to displace the cam member in a direction which returns the elongate steering shaft towards the straight ahead position.

By providing a spring means connected with a lever, the spring means can be maintained in a state of compression or tension throughout rotation of the elongate steering shaft. This provides a constant direction of bias in the mechanism, thereby to minimise the likelihood and/or effect of backlash. Furthermore, the arrangement can improve the operating life of the spring means.

The lever may be arranged to support the cam follower so as allow displacement thereof about the lever pivot as the elongate steering column or cam member is rotated.

The steering column assembly may be or may comprise a steering column return assembly.

In an embodiment, the spring means is pivotally connected to the lever.

An end of the spring means may be pivotally connected to the lever.

The spring means may be pivotally connected to the lever by a hinge. The spring means may be connected to the lever by a ball joint. The spring may comprise a cap at an end thereof comprising a ball socket. The lever may comprise a ball received within the ball socket.

The spring means may act upon the lever.

An end of the spring means may act upon the lever.

An end of the spring means may be connected, e.g. pivotally connected, to a pivot, e.g. a spring pivot. The spring means may comprise a spring anchor. An end of the spring means may be connected to a spring anchor. The spring anchor may comprise a pivot, e.g. the spring pivot.

An end of the spring means may be connected to a fixed joint, fixed point or a fixed spring anchor. The spring anchor may comprise a fixed joint or a fixed point. The fixed joint or fixed point may be connected to a fixed point within the steering column assembly. The spring pivot may be or may comprise a fulcrum, e.g. a spring fulcrum.

The spring means may comprise a cap or bracket. An end of the spring means may comprise a cap or bracket. The cap or bracket may be pivotally connected to a fulcrum or pivot. The cap or bracket may be connected to the spring pivot.

The rotational axis of the spring pivot may be offset from the rotational axis of the elongate steering shaft.

The spring means may be or may comprise a compression spring. The spring means may be or may comprise a helical spring. The compression spring may be or may comprise a helical spring or helical compression spring.

The spring means may comprise a plurality of springs, e.g. arranged or mounted coaxially. The spring means may comprise a pair of springs, e.g. arranged or mounted coaxially. Each of the springs may have a different diameter.

The spring means may be or may comprise one or more compression springs. The spring means may be or may comprise a plurality, e.g. a pair, of compression springs.

The plurality of compression springs may be identical. The plurality of compression springs may be spaced from one another.

The plurality of compression springs may be arranged parallel or coaxially with one another. The plurality of compression springs may connected via a yoke.

The spring means may be or may comprise a tension spring. The tension spring may be or may comprise a helical spring or helical tension spring.

The spring means may be or may comprise one or more tension springs. The spring means may be or may comprise a plurality, e.g. a pair, of tension springs.

The plurality of tension springs may be identical. The plurality of tension springs may be spaced from one another.

The plurality of tension springs may be arranged parallel or coaxially with one another. The plurality of tension springs may be connected via a yoke.

The spring means may be or may comprise a torsion spring.

The spring means may be or may comprise one or more torsion springs. The spring means may be or may comprise a plurality, e.g. a pair, or torsion springs.

The plurality of torsion springs may be identical. The plurality of torsion springs may be spaced from one another.

The spring means may be pre-loaded.

The compression spring may be configured to be under constant compression as the elongate steering column or cam member is rotated.

The tension spring may be configured to be under constant tension as the elongate steering column or cam member is rotated.

The spring means may comprise one or more elements configured to store energy when displaced, e.g. coiled springs, coiled steel springs, resin-impregnated carbon structures, glass fibre structures, gas springs, gas struts and/or any other suitable elastomeric component(s).

The cam surface may be or may comprise an annular surface or radial surface of the cam member.

The cam member may be an annular or part-annular cam member.

The cam surface may be or may comprise a cam track.

The cam surface may be or may comprise a radially inner surface of the cam member. Additionally or alternatively, the cam surface may be or may comprise a radially outer surface of the cam member.

The cam follower may be located radially inward of the cam surface.

The spring means may be configured to bias the cam follower radially outward into contact with the radially inner surface of the cam member.

The cam follower may be located radially outward of the cam surface.

The spring means may be configured to bias the cam follower radially inward into contact with the radially outer surface of the cam member.

The cam member may be generally circular when viewed along the longitudinal axis of the elongate steering column.

The cam member may be eccentrically mounted to the elongate steering column.

The cam member may be mounted to an end of the elongate steering column.

The rotational axis of the elongate steering shaft, the rotational axis of the lever pivot and/or the rotational axis of the spring pivot may be substantially parallel to, and offset from, one another.

In an embodiment, the cam surface comprises an annular or part-annular end surface of the cam member.

The annular or part-annular end surface may be on a lower end or lower side of the cam member. The lower end or lower side of the cam member may be the other end or side from which steering member would be located, in use.

A centre of the annular or part-annular cam surface may offset from the longitudinal axis of the elongate steering column.

The height of the cam surface may vary along its length. The height of the cam surface may vary along its arc length.

The cam surface, or cam member may be configured to provide a non-linear torque vs steering angle profile.

The distance between the cam follower and the spring pivot and/or lever pivot may change as the cam member or elongate steering shaft is rotated.

The distance between the cam surface and the spring pivot and/or lever pivot may change as the cam member or elongate steering shaft is rotated. The distance between a portion of, or a point on, the cam surface and the spring pivot and/or lever pivot may change as the cam member or elongate steering shaft is rotated. The distance between a contact point between the cam follower and the cam surface and the spring pivot and/or lever pivot may change as the cam member or elongate steering shaft is rotated.

The lever may be substantially annular or part-annular. The lever pivot and the cam follower may be located at diametrically opposed sides of the lever.

The rotational axis of the lever pivot and the rotational axis of the spring pivot may be substantially parallel and offset from one another.

The rotational axis of the elongate steering column may extend substantially transverse to the rotational axes of the lever pivot and the spring pivot.

The cam follower may be configured to roll or rotate over the cam surface as the elongate steering column or cam member is rotated.

The cam follower may comprise a roller.

The cam follower may comprise a roller bearing, ball bearing or an annular bearing.

The spring pivot may comprise a bearing. The bearing may comprise a roller bearing or a ball bearing. The spring pivot may comprise a plain bushing.

The lever pivot may comprise a bearing. The bearing may comprise a roller bearing or a ball bearing. The lever pivot may comprise a plain bushing.

In an embodiment, the cam surface is asymmetrical either side of a location corresponding to the straight ahead position of the elongate steering column and/or cam member.

The elongate steering column and/or cam member may be constrained to rotate a maximum of a half turn in either direction from the straight ahead position.

In an embodiment, the elongate steering column and/or cam member may be constrained to rotate between 150 and 180 degrees in either direction from the straight ahead position, for example between 155 and 175 degrees, or between 160 and 170 degrees. The elongate steering column and/or cam member may be constrained to rotate 170 degrees in either direction from the straight ahead position.

The steering column assembly may comprise an end stop at each end of the cam member, cam surface or cam track, e.g. to constrain the rotation of the elongate steering column and/or cam member.

The steering column assembly may comprise a spring housing. The spring may be received within the spring housing. The spring housing may be pivotally connected to the lever.

The lever pivot may be offset from the rotational axis of the elongate steering shaft.

The steering column assembly may be for a steer-by-wire vehicle.

In accordance with another aspect of the invention, there is provided a steering column return assembly for a vehicle, comprising:
a cam member comprising a cam surface, wherein the cam member is constrained to rotate with an elongate steering shaft of a vehicle;
a cam follower in contact with the cam surface;
a lever connected to a lever pivot and arranged to support the cam follower; and
spring means connected to the lever and biasing the cam follower into contact with the cam surface via the lever;
wherein, in use, the spring means urges the cam follower to displace the cam member in a direction which returns the elongate steering shaft towards the straight ahead position.

In accordance with another aspect of the invention, there is provided a vehicle comprising a steering column assembly as described above.

For the avoidance of doubt, any of the features described herein apply equally to any aspect of the invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a schematic illustration of a steer-by-wire steering system in accordance with the present invention;

FIG. 2 is a schematic illustration of a first embodiment of steering column assembly for use with the steer-by-wire steering system of FIG. 1;

FIG. 3 is a plan view of a second embodiment of steering column assembly for use with the steer-by-wire steering system of FIG. 1, shown with elongate steering shaft rotated anti-clockwise from a straight ahead position;

FIG. 4 is a schematic plan view illustration of a third embodiment of steering column assembly for use with the steer-by-wire steering system of FIG. 1;

FIG. 5 is a schematic plan view illustration of a fourth embodiment of steering column assembly for use with the steer-by-wire steering system of FIG. 1;

FIG. 6 is a schematic plan view illustration of a fifth embodiment of steering column assembly for use with the steer-by-wire steering system of FIG. 1;

FIG. 7 is a schematic illustration of a sixth embodiment of steering column assembly for use with the steer-by-wire steering system of FIG. 1;

FIG. 8 is a schematic illustration of a seventh embodiment of steering column assembly for use with the steer-by-wire steering system of FIG. 1;

FIG. 9 is a schematic illustration of a eighth embodiment of steering column assembly for use with the steer-by-wire steering system of FIG. 1;

FIG. 10 is a schematic illustration of a ninth embodiment of steering column assembly for use with the steer-by-wire steering system of FIG. 1;

FIG. 11 is a schematic side view illustration of a tenth embodiment of steering column assembly for use with the steer-by-wire steering system of FIG. 1;

FIG. 12 is an exploded perspective view of the steering column assembly of FIG. 11;

FIG. 13 is an exploded side view of the steering column assembly of FIG. 11;

FIG. 14 is a vertical cross-section through the steering column assembly of FIGS. 11 to 13 at a first steering angle; and

FIG. 15 is a vertical cross-section through the steering column assembly of FIGS. 11 to 13 at a second steering angle.

### DESCRIPTION

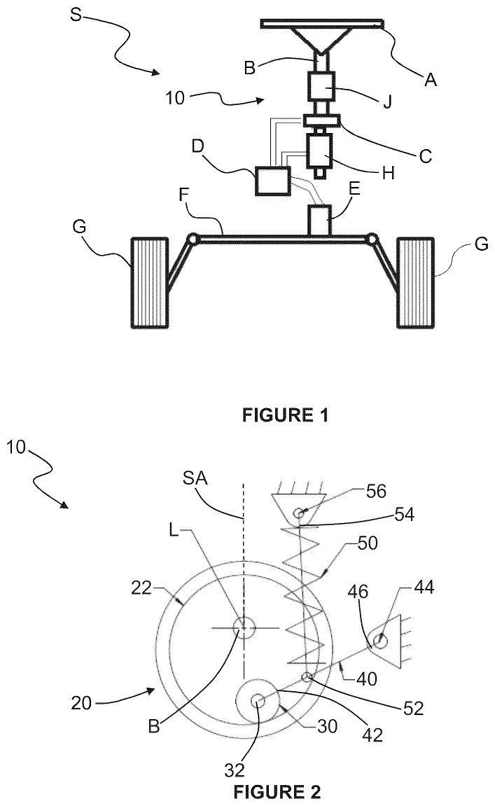

FIG. 1 illustrates a steer-by-wire system S for a vehicle incorporating a steering column assembly 10 in accordance with the present invention. The steer-by-wire system S includes a handwheel actuator, in the form of a steering wheel A, to allow a driver of the vehicle to provide an input steering command. The steering wheel A is connected to an end of an elongate steering shaft B.

A steering input applied through the steering wheel A is measured by a steering sensor forming part of the steering column assembly, shown schematically at C in FIG. 1. A signal representative of the steering input (i.e. the rotation of the steering wheel A and elongate steering shaft B) is transmitted from the sensor C to an electronic control unit (ECU) D which, in turn, controls a steering axle actuator E. The steering axle actuator E applies the steering input to the steering axle F, and therefore steers the steered wheels G as a function of the rotational position of the steering wheel A.

The electronic control unit D is also configured to supply a current to a torque feedback motor H connected to the elongate steering shaft B and which applies a torque in the opposite direction to the torque applied at the steering wheel A in order to provide a sensation of “road feel” to the driver.

A steering column return assembly J is also mounted on the elongate steering shaft B. In this embodiment, the steering column return assembly J is mounted between the steering wheel A and the sensor C, but it could be mounted at other locations on the elongate steering shaft B. The purpose of the steering column return assembly is to apply a torque to the elongate steering shaft B (and the steering wheel A) in a direction opposite to that applied by a driver, to assist a driver in returning the elongate steering shaft B (and the steering wheel A) to the straight ahead position.

A first embodiment of a steering column assembly 10 forming part of the steer-by-wire system S of FIG. 1 is shown in FIG. 2. The steering column assembly 10 includes an elongate steering shaft B mounted for rotation about its longitudinal axis. The elongate steering shaft B is rotatable in both directions from a position corresponding to a straight ahead position SA as shown in FIG. 2.

An cam member 20 is configured to rotate with the elongate steering shaft B and includes a cam surface 22 on its inner face. A cam follower 30 is located at the end of a lever 40 and is in contact with the cam surface 22. A compression spring 50 is connected between ends of the lever 40 and biases the cam follower 30 into contact with the cam surface 22 via the lever 40. In use, the compression spring 50 urges the cam follower 30 to displace the cam member 20 in a direction which returns the elongate steering shaft B towards the straight ahead position SA.

The cam member 20 is mounted eccentrically with respect to the elongate steering shaft B. The cam surface 22 is formed on an inner face of the cam member 20 in this embodiment. Although not shown in FIG. 2, the cam member 20 is configured to provide a spring return force or restoring torque to the elongate steering shaft B (FIG. 1) that varies in a non-linear manner with the angle of rotation of steering wheel A (FIG. 1). In general, the cam member 20 is not perfectly circular or symmetric. Further, although not shown, the cam surface 22 is asymmetric either side of a location corresponding to the straight ahead position of the cam member 20.

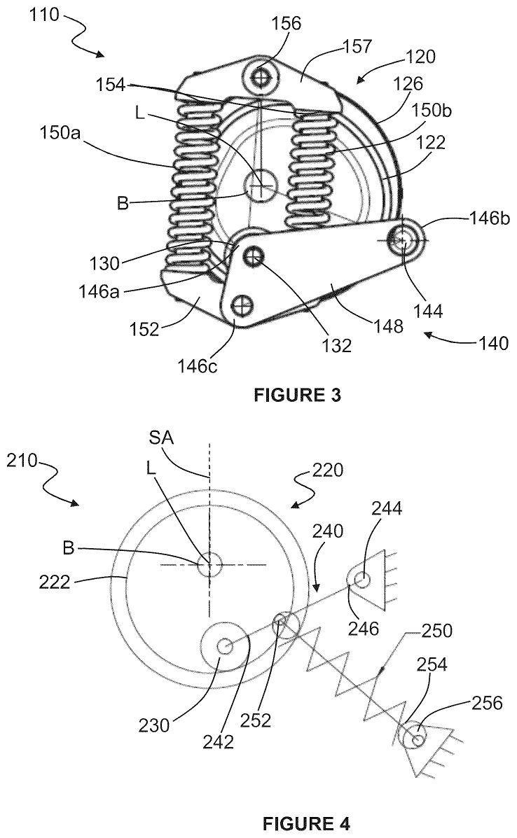

The cam follower 30 is located radially inward of the cam surface 22 and is a roller bearing in this embodiment. The cam follower 30 is rotatably mounted proximate a free end 42 of the lever 40 and has an axis of rotation 32. The lever 40 may comprise a plate, for example as is shown in FIG. 3, but is not shown in the schematic of FIG. 2. The lever 40 is connected to a lever pivot 44 at the other of its ends 46. The lever pivot 44 is connected to a fixed point within the steering column assembly 10.

The compression spring 50 is a helical spring in this embodiment, and has a first end 52 pivotally connected to the lever 40 between its ends 42, 46. A second end 54 of the compression spring 50 is pivotally connected to a spring pivot 56. The compression spring 50 is pre-loaded in this embodiment such that is continuously biases the cam follower 30 away from the spring pivot 56 and into contact with the cam surface 22.

The rotational axis of the elongate steering shaft B, the rotational axis of the lever pivot 44 and the rotational axis of the spring pivot 56 are substantially parallel to, and offset from, one another.

In use, as the elongate steering shaft B is rotated in either direction from the straight ahead position SA, the cam member 20 and cam surface 22 are also rotated. The cam follower 30 is configured to roll over the cam surface 22 and due to the eccentrically mounted cam member 20 the distance between the spring pivot 56 and the axis of rotation 32 of the cam follower 30 is changed as the elongate steering column B is rotated. The lever 40 supports the cam follower 30 so as allow displacement thereof about the lever pivot 44. As the compression spring 50 is pivotally connected to the lever 40 and the spring pivot 56, the direction of spring loading is adjusted as the cam follower 30 is displaced.

In the case of the arrangement of FIG. 2, if the elongate steering column B were to be rotated clockwise from the straight ahead position SA, the distance between the cam follower 30 and the spring pivot 56 would be reduced. This would result in clockwise rotation of the lever 40 about the lever pivot 44, causing contraction and further compression of the pre-loaded compression spring 50. As the lever 40 is rotated clockwise the biasing force applied by the compression spring 50 to the lever 40, and therefore cam follower 30, is increased. Therefore, the contact force between the cam surface 22 and the cam follower 30 is increased. The direction of the contact force is generally normal to the cam surface 22 and the geometry or configuration of the cam surface 22 urges the cam follower 30 to displace the cam member 20 and elongate steering shaft B in an anti-clockwise direction towards the straight ahead position SA.

It will be appreciated that whilst the steering column assembly 10 of FIG. 2 shows a single compression spring 50, this need not be the case. In some embodiments, the compression spring may comprise a pair of compression springs, as described below in respect of FIG. 3. The steering column assembly may comprise more than one spring arranged coaxially, in parallel and/or in series.

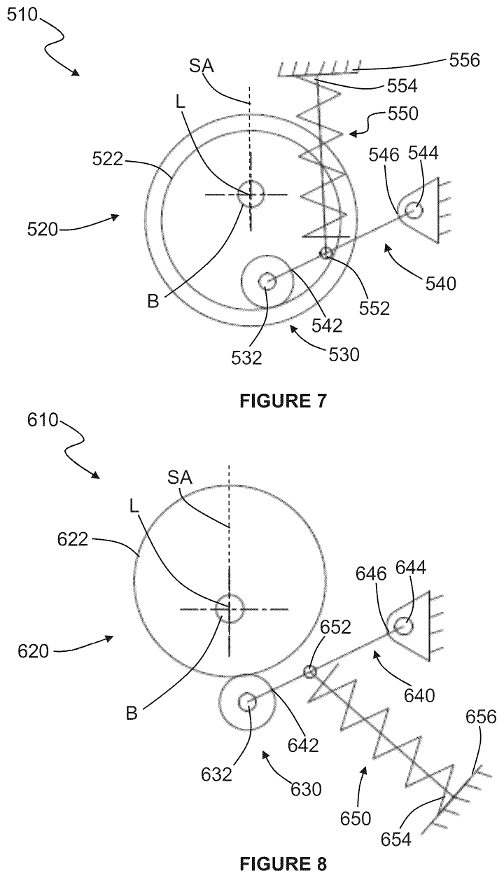

It will also be appreciated that instead of providing compression spring 50 connected to a spring pivot 56 at its second end 54, it may instead be connected to a fixed point 556 as shown in the sixth embodiment of FIG. 7. The fixed point 556 may be connected to a fixed point within the steering column assembly 510 or a fixed point within a housing (not shown) of the compression spring 550. In the case of the steering column assembly 510 of FIG. 7, the compression spring 550 may flex along its longitudinal axis to accommodate displacement of the lever 540 during rotation of the cam member 520. The steering column assembly 510 of FIG. 7 is similar to the steering column assembly 10 of FIG. 2 wherein like features are denoted by like references incremented by ‘500’ and in the interest of brevity will not be described further.

A second embodiment of a steering column assembly 110 forming part of the steer-by-wire system S of FIG. 1 is shown in FIG. 3. The steering column assembly 110 is similar to the steering column assembly of FIG. 2, wherein like features are denoted by like references incremented by ‘100’ and in the interest of brevity only the differences will be described in detail hereinafter.

The cam member 120 is configured to rotate with the elongate steering shaft B and has a generally circular outer periphery 126 when viewed along the longitudinal axis L. The cam member 120 includes an asymmetric cam surface 122 either side of a location corresponding to the straight ahead position of the cam member 120.

The cam follower 130 is rotatably mounted to a first vertex 146a of a generally triangular plate 148 of the lever 140 and is in contact with the cam surface 122. The plate 148 is connected to the lever pivot 144 at a second of its vertices 146b.

In the present embodiment, a pair of compression springs 150a, 150b are provided, each connected to an opposite end of a generally U-shaped mounting yoke 152 at their respective first end. The mounting yoke 152 is pivotally connected to a third vertex 146c of the plate 148 such that the rotational axis thereof is positioned centrally between longitudinal axes of the compression springs 150a, 150b. The mounting yoke 152 is connected to the plate 148 radially outward of the axis of rotation 132 of the cam follower 130.

A respective second end 154 of each of the compression springs 150a, 150b is connected to an opposite end of a further generally U-shaped mounting yoke 157. The mounting yoke 157 is connected to a spring pivot 156. The further mounting yoke 157 is pivotally mounted such that the rotational axis thereof is positioned centrally between longitudinal axes of the compression springs 150a, 150b.

The compression springs 150a, 150b bias the cam follower 130 into contact with the cam surface 122 via the mounting yoke 152 connected to the lever 140.

The rotational axis of the elongate steering shaft B, the rotational axis of the lever pivot 144 and the rotational axis of the spring pivot 156 are substantially parallel to, and offset from, one another.

As the compression springs 150a, 150b are pivotally connected to the lever 140 and the spring pivot 156 by virtue of the mounting yokes 152, 157, their rotation is coupled such that the direction of spring loading is adjusted as the cam follower 130 is displaced.

In the case of the arrangement of FIG. 3, the elongate steering column B is shown to be in a position in which it has been rotated anti-clockwise from the straight ahead position. When rotating the elongate steering column B from the straight ahead position to the position of FIG. 3, the distance between the cam follower 130 and the spring pivot 156 is reduced, resulting in clockwise rotation of the lever 140 about the lever pivot 144. This causes compression of the pre-loaded compression springs 150a, 150b. As the lever 140 is rotated clockwise the biasing force applied by the compression springs 150a, 150b to the lever 140, and therefore cam follower 130, is increased. Therefore, the contact force between the cam surface 122 and the cam follower 130 is increased. The direction of the contact force is generally normal to the cam surface 122 and the geometry or configuration of the cam surface 122 urges the cam follower 130 to displace the cam member 120 and elongate steering shaft B in a clockwise direction towards the straight ahead position.

A third embodiment of a steering column assembly 210 forming part of the steer-by-wire system S of FIG. 1 is shown in FIG. 4. The steering column assembly 210 is similar to the steering column assembly of FIG. 2, wherein like features are denoted by like references incremented by ‘200’ and in the interest of brevity only the differences will be described in detail hereinafter.

The main difference between the steering column assembly 10 of FIG. 2 and the steering column assembly 210 is that in the present arrangement the spring is a tension spring 250 instead of a compression spring.

The tension spring 250 is a helical spring in this embodiment, and has a first end 252 pivotally connected to the lever 240 between its ends 242, 246. A second end 254 of the tension spring 250 is connected to a spring pivot 256 that is located on the other side of the lever pivot 244 than in the case of FIG. 2. The tension spring 250 is pre-loaded in this embodiment such that is continuously biases the cam follower 230 towards the spring pivot 256 and into contact with the cam surface 222. Although not shown, the cam surface 222 is asymmetric either side of a location corresponding to the straight ahead position of the cam member 220

In use, the tension spring 250 urges the cam follower 230 to displace the cam member 220 in a direction which returns the elongate steering shaft B towards the straight ahead position SA.

The rotational axis of the elongate steering shaft B, the rotational axis of the lever pivot 244 and the rotational axis of the spring pivot 256 are substantially parallel to, and offset from, one another.

In the case of the arrangement of FIG. 4, if the elongate steering column B were to be rotated clockwise from the straight ahead position SA, the distance between the cam follower 230 and the spring pivot 256 would be increased. This would result in clockwise rotation of the lever 240 about the lever pivot 244, causing elongation of the pre-loaded tension spring 250. As the lever 240 is rotated clockwise the biasing force applied by the tension spring 250 to the lever 240, and therefore cam follower 230, is increased. Therefore, the contact force between the cam surface 222 and the cam follower 230 is increased. The direction of the contact force is generally normal to the cam surface 222 and the geometry or configuration of the cam surface 222 urges the cam follower 230 to displace the cam member 220 and elongate steering shaft B in an anti-clockwise direction towards the straight ahead position SA.

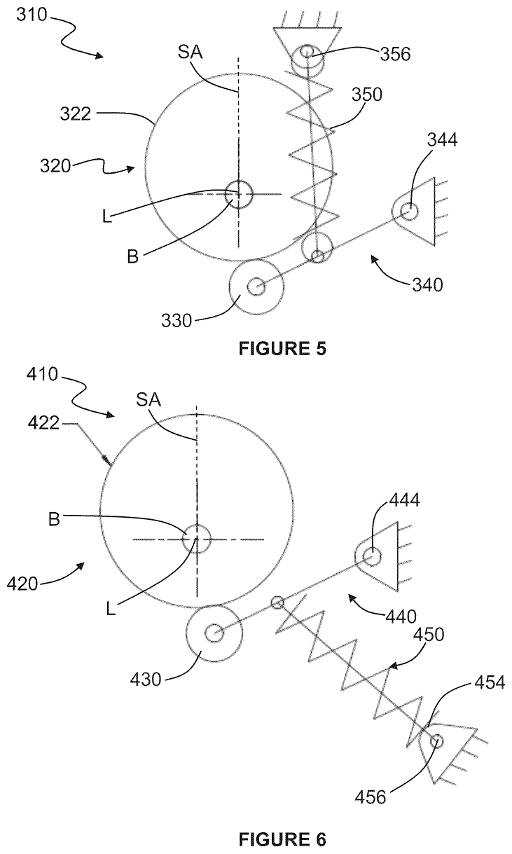

A fourth embodiment of a steering column assembly 310 forming part of the steer-by-wire system S of FIG. 1 is shown in FIG. 5. The steering column assembly 310 is similar to the steering column assembly of FIG. 2, wherein like features are denoted by like references incremented by ‘300’ and in the interest of brevity only the differences will be described in detail hereinafter.

The main differences between the steering column assembly 10 of FIG. 2 and the steering column assembly 310 are that in the present arrangement the cam surface 322 is formed on a radially outer surface of the cam member 320 and the spring is a tension spring 350 instead of a compression spring. The cam follower 330 is also located radially outward of the cam member 320.

In the case of the arrangement of FIG. 5, if the elongate steering column B were to be rotated clockwise from the straight ahead position SA, the distance between the cam follower 330 and the spring pivot 356 would be increased. This would result in anti-clockwise rotation of the lever 340 about the lever pivot 344, causing elongation of the pre-loaded tension spring 350. As the lever 340 is rotated anti-clockwise the biasing force applied by the tension spring 350 to the lever 340, and therefore cam follower 330, is increased. Therefore, the contact force between the cam surface 322 and the cam follower 330 is increased. The direction of the contact force is generally normal to the cam surface 322 and the geometry or configuration of the cam surface 322 urges the cam follower 330 to displace the cam member 320 and elongate steering shaft B in an anti-clockwise direction towards the straight ahead position SA.

A fifth embodiment of a steering column assembly 410 forming part of the steer-by-wire system S of FIG. 1 is shown in FIG. 6. The steering column assembly 410 is similar to the steering column assembly 310 of FIG. 5, wherein like features are denoted by like references incremented by ‘100’ and in the interest of brevity only the differences will be described in detail hereinafter.

The main difference between the steering column assembly 310 of FIG. 5 and the steering column assembly 410 of FIG. 6 is that in the present arrangement the spring is a compression spring 450 instead of a tension spring.

A second end 454 of the compression spring 450 is connected to a spring pivot 456 that is located on the other side of the lever pivot 444 than in the case of FIG. 5. The compression spring 450 is pre-loaded in this embodiment such that it continuously biases the cam follower 430 away from the spring pivot 456 and into contact with the cam surface 422.

In the case of the arrangement of FIG. 6, if the elongate steering column B were to be rotated clockwise from the straight ahead position SA, the distance between the cam follower 430 and the spring pivot 456 would be decreased. This would result in anti-clockwise rotation of the lever 440 about the lever pivot 444, causing contraction or compression of the pre-loaded compression spring 450. As the lever 440 is rotated anti-clockwise the biasing force applied by the compression spring 450 to the lever 440, and therefore cam follower 430, is increased. Therefore, the contact force between the cam surface 422 and the cam follower 430 is increased. The direction of the contact force is generally normal to the cam surface 422 and the geometry or configuration of the cam surface 422 urges the cam follower 430 to displace the cam member 420 and elongate steering shaft B in an anti-clockwise direction towards the straight ahead position SA.

It will also be appreciated that instead of providing compression spring 450 connected to a spring pivot 456 at its second end 454, it may instead be connected to a fixed point 656 as shown in the seventh embodiment of FIG. 8. The fixed point 656 may be connected to a fixed point within the steering column assembly 610 or a fixed point within a housing (not shown) of the compression spring 650. In the case of the steering column assembly 610 of FIG. 8, the compression spring 650 may flex along its longitudinal axis to accommodate displacement of the lever 640 during rotation of the cam member 620. The steering column assembly 610 of FIG. 8 is similar to the steering column assembly 410 of FIG. 6 wherein like features are denoted by like references incremented by ‘200’ and in the interest of brevity will not be described further.

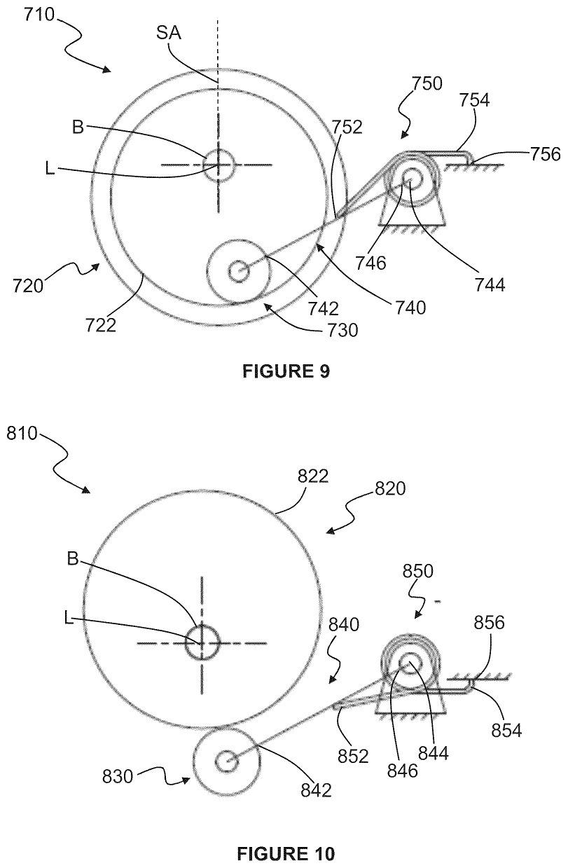

An eighth embodiment of a steering column assembly 710 forming part of the steer-by-wire system S of FIG. 1 is shown in FIG. 9.

The steering column assembly 710 is similar to the steering column assembly of FIG. 4, wherein like features are denoted by like references incremented by ‘500’ and in the interest of brevity only the differences will be described in detail hereinafter.

The main difference between the steering column assembly 710 of FIG. 9 and the steering column assembly 210 is that in the present arrangement the spring is a torsion spring 750 instead of a tension spring.

The torsion spring 750 has a first end 752 in contact with, and acting upon, the lever 740 between its ends 742, 746. A second end 754 of the torsion spring 750 is connected to a fixed point 756 of the steering column assembly 710. The torsion spring 750 applies a torque about the lever pivot 744 and is arranged such that the torque applied to the lever 740 increases as the elongate steering shaft B is rotated away from the straight ahead position SA. The torsion spring 750 is pre-loaded in this embodiment such that is continuously biases the cam follower 730 into contact with the cam surface 722. Although not shown, the cam surface 722 is asymmetric either side of a location corresponding to the straight ahead position of the cam member 720

In use, the torsion spring 750 urges the cam follower 730 to displace the cam member 720 in a direction which returns the elongate steering shaft B towards the straight ahead position SA.

An ninth embodiment of a steering column assembly 810 forming part of the steer-by-wire system S of FIG. 1 is shown in FIG. 10.

The steering column assembly 810 is similar to the steering column assembly of FIG. 5, wherein like features are denoted by like references incremented by ‘500’ and in the interest of brevity only the differences will be described in detail hereinafter.

The main difference between the steering column assembly 810 of FIG. 10 and the steering column assembly 310 is that in the present arrangement the spring is a torsion spring 850 instead of a tension spring. The torsion spring 850 of FIG. 10 operates in a similar manner to torsion spring 750 of FIG. 9, and will not be described further.

In use, the tension spring 850 urges the cam follower 830 to displace the cam member 820 in a direction which returns the elongate steering shaft B towards the straight ahead position SA.

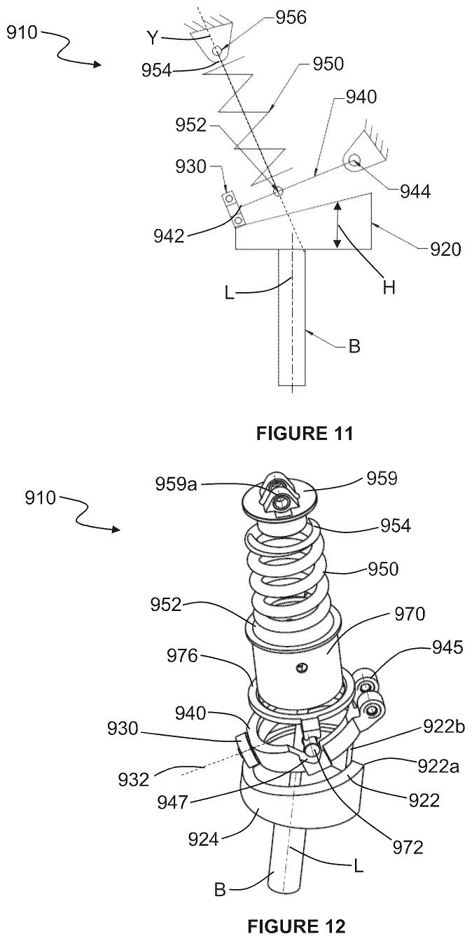

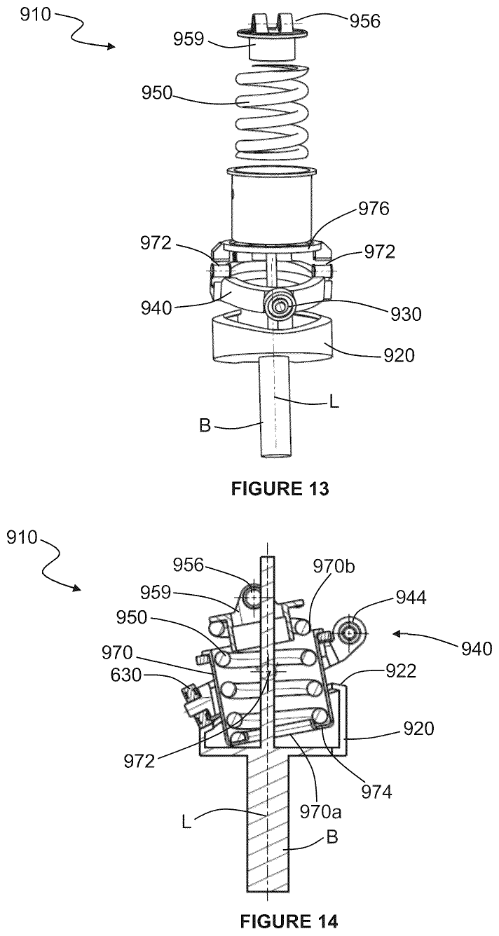

A tenth embodiment of a steering column assembly 910 forming part of the steer-by-wire system S of FIG. 1 is shown in FIGS. 11 to 15. The steering column assembly 910 includes an elongate steering shaft B mounted for rotation about its longitudinal axis. The elongate steering shaft B is rotatable in both directions from a position corresponding to a straight ahead position as shown in FIG. 11.

A part-annular cam member 920 is configured to rotate with the elongate steering shaft B and includes a part-annular cam surface 922. A cam follower 930 is located on one side of a part-annular lever 940 and is in contact with the cam surface 922. A compression spring 950 is connected between ends of the lever 940 and biases the cam follower 930 into contact with the cam surface 922 via the lever 940.

The cam member 920 is generally circular when viewed along the longitudinal axis L and is mounted eccentrically with respect to the elongate steering shaft B. The cam member 920 is arranged such that the cam follower 930 contacts the cam surface 922 as the lever 940 articulates. The cam surface 922 is formed on a part-annular end surface of an annular wall 924 in this embodiment. The cam surface 922 extends between terminal ends 922a, 922b and its height H (as shown in FIG. 11) varies along its arc length. The variation in height H may be configured such that the restoring torque imposed on the elongate steering shaft B varies in a non-linear manner with the angle of rotation of the steering wheel A (FIG. 1).

The cam follower 930 is in contact with the cam surface 922 and is a roller bearing in this embodiment. The cam follower 930 is rotatably mounted on one side 942 of the lever 940 and has an axis of rotation 932. The lever 940 is part-annular and is connected to a lever pivot 944 via a pair of spaced lugs 945. The lever pivot 944 and cam follower 930 are located at diametrically opposed sides of the lever 940.

The compression spring 950 is a helical spring in this embodiment, and is enclosed within a cylindrical housing 970. The cylindrical housing 970 is rotatably connected to the lever 940 by a pair of opposed projecting lugs 972. The spring compression spring 950 has a first end 952 located within an annular channel 974 at a base 970a of the housing 970 and is pivotally connected to the lever 940 via the housing 970. Each of the pair of lugs 972 extend from a support ring 976 and are received within a respective recess 947 of the lever 940. A second end 954 of the compression spring 950 extends from an open end 970b of the housing 970 and is provided with a cap 959 connected to a spring pivot 956 via a pair of spaced lugs 959a. The compression spring 950 is pre-loaded in this embodiment such that it continuously biases the cam follower 930 away from the spring pivot 956 and into contact with the cam surface 922.

The cylindrical housing 970 allows for a more compact arrangement in the direction of the longitudinal axis L.

The rotational axis of the elongate steering shaft B extends substantially transverse to the rotational axis of the lever pivot 944 and the rotational axis of the spring pivot 956. The rotational axis of the lever pivot 944 and the rotational axis of the spring pivot 956 are substantially parallel to, and offset from, one another. Furthermore, the longitudinal axis Y of the compression spring 950 extends at an angle with respect to the longitudinal axis L of the elongate steering shaft B.

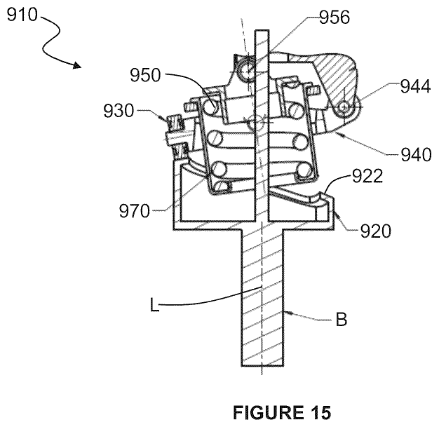

FIG. 14 shows the steering column assembly 910 when the elongate steering shaft B is in a straight ahead position. FIG. 15 shows the steering column assembly 910 when the elongate steering shaft B has been rotated 150 degrees from the straight ahead position.

In use, as the elongate steering shaft B is rotated in either direction from the straight ahead position of FIG. 14 to the position of FIG. 15, the cam member 920 and cam surface 922 are also rotated. The cam follower 930 is configured to roll over the cam surface 922 and due to the change in height H of the cam surface 922 the distance between the spring pivot 956 and the axis of rotation 932 of the cam follower 930 is reduced. The lever 940 supports the cam follower 930 so as allow displacement thereof about the lever pivot 944. The lever 940 also pivotally supports the cylindrical housing 970 via the projecting lugs 972.

Rotation of the elongate steering shaft B would result in upwards rotation of the lever 940 about the lever pivot 944 (clockwise rotation in FIGS. 14 and 15), causing displacement of the cylindrical housing 970 towards the spring pivot 956 and contraction and further compression of the pre-loaded compression spring 950. As the lever 940 is rotated clockwise the biasing force applied by the compression spring 950 to the lever 940 via the cylindrical housing 970, and therefore cam follower 930, is increased. Therefore, the contact force between the cam surface 922 and the cam follower 930 is increased. The direction of the contact force is generally normal to the cam surface 922 and the geometry or configuration of the cam surface 922 urges the cam follower 930 to displace the cam member 920 and elongate steering shaft B towards the straight ahead position of FIG. 14.

As the compression spring 950 is pivotally connected to the lever 940 and the spring pivot 956, the direction of spring loading is adjusted as the cam follower 930 is displaced.

It will be appreciated by those skilled in the art that several variations to the aforementioned embodiments are envisaged without departing from the scope of the invention.

It will also be appreciated by those skilled in the art that any number of combinations of the aforementioned features and/or those shown in the appended drawings provide clear advantages over the prior art and are therefore within the scope of the invention described herein.

1. A steering column assembly for a vehicle, comprising:
an elongate steering shaft mounted for rotation about its longitudinal axis and configured for attachment of a steering member at one end, the steering shaft being rotatable in both directions from a position corresponding to a straight ahead position;
a cam member comprising a cam surface, wherein the cam member is constrained to rotate with the steering shaft;
a cam follower in contact with the cam surface;
a lever connected to a lever pivot and arranged to support the cam follower; and
spring means connected to the lever and biasing the cam follower into contact with the cam surface via the lever;
wherein spring means urges the cam follower to displace the cam member in a direction which returns the elongate steering shaft towards the straight ahead position.

2. A steering column assembly according to claim 1, wherein the spring means is pivotally connected to the lever.

3. A steering column assembly according to claim 2, wherein an end of the spring means is connected to a spring pivot.

4. A steering column assembly according to claim 2, wherein an end of the spring means is connected to a fixed spring anchor.

5. A steering column assembly according to claim 1, wherein the spring means comprises a compression spring.

6. A steering column assembly according to claim 5, wherein the spring means comprises a pair of spaced compression springs.

7. A steering column assembly according to claim 1, wherein the spring means comprises a tension spring.

8. A steering column assembly according to claim 1, wherein the spring means comprises a torsion spring.

9. A steering column assembly according to claim 1, wherein the cam surface comprises a radially inner surface of the cam member.

10. A steering column assembly according to claim 1, wherein the cam surface comprises a radially outer surface of the cam member.

11. A steering column assembly according to claim 9 when dependent on claim 3, wherein the rotational axis of the elongate steering shaft, the rotational axis of the lever pivot and the rotational axis of the spring pivot are substantially parallel to, and offset from, one another.

12. A steering column assembly according to claim 1, wherein the cam surface comprises an annular or part-annular end surface of the cam member.

13. A steering column assembly according to claim 12, wherein the height of the cam surface varies along its length.

14. A steering column assembly according to claim 12, wherein the lever is substantially annular or part-annular, and wherein the lever pivot and cam follower are at diametrically opposed sides thereof.

15. A steering column assembly according to claim 12, when dependent on claim 3, wherein the rotational axis of the lever pivot and the rotational axis of the spring pivot are substantially parallel to, and offset from, one another.

16. A steering column assembly according to claim 15, wherein the rotational axis of the elongate steering column extends substantially transverse to the rotational axes of the lever pivot and the spring pivot.

17. A steering column assembly according to claim 1, wherein the cam follower is configured to roll over the cam surface as the cam member is rotated.

18. A steering column assembly according to claim 17, wherein the cam follower comprises a roller bearing or a ball bearing.

19. A steering column assembly according to claim 1, wherein the cam surface is asymmetrical either side of a location corresponding to the straight ahead position of the cam member.

20. A steering column assembly according to claim 1, wherein the elongate steering column is constrained to rotate a maximum of a half turn in either direction from the straight ahead position.

21. A steering column assembly according to claim 1, comprising a spring housing and wherein the spring is received within the spring housing, wherein the spring housing is pivotally connected to the lever.

22. A steering column assembly according to claim 1, wherein the lever pivot is offset from the rotational axis of the elongate steering shaft.

23. A steering column assembly according to claim 1 for a steer-by-wire vehicle.

24. A steering column return assembly for a vehicle, comprising:
a cam member comprising a cam surface, wherein the cam member is constrained to rotate with an elongate steering shaft of a vehicle;
a cam follower in contact with the cam surface;
a lever connected to a lever pivot and arranged to support the cam follower; and
spring means connected to the lever and biasing the cam follower into contact with the cam surface via the lever;
wherein, in use, the spring means urges the cam follower to displace the cam member in a direction which returns the elongate steering shaft towards the straight ahead position.

25. A vehicle comprising a steering column assembly as claimed in claim 1.

26. A vehicle comprising a steering column return assembly according to claim 24.
